(19) United States
(12) Patent Application Publication
(10) Pub. No.: US 2002/0004331 A1
(43) Pub. Date: Jan. 10, 2002

(54) Insulation-displacement terminal fitting

(76) Inventors: Masahide Hio, Yokkaichi-city (JP); Eiji Kojima, Yokkaichi-city (JP)

Correspondence Address: CASELLA & HESPOS, 274 MADISON AVENUE, NEW YORK, NY, 10016

(21) Appl. No.: 09/893,931

(22) Filed: Jun. 28, 2001

(30) Foreign Application Priority Data
Jul. 10, 2000 (JP) 2000-208272

(51) Int. Cl. H01R 4/24

(52) U.S. Cl. 439/397

(57) ABSTRACT

An insulation-displacement terminal fitting (T) includes a pair of insulation-displacement portions (15) that project inwardly substantially in V-shape from side walls (12) to be connected with a wire (W) by insulation displacement. The side walls (12) are formed with substantially I-shaped locks (17) that project in positions spaced from the insulation-displacement portions (15) along the longitudinal direction of the wire (W) and can bite in a resin coating (Wa). An external force may try to move the wire (W) along its longitudinal direction acts. However, the locks (17) catch the resin coating (Wa) to restrict a loose movement of the wire (W).

### BACKGROUND OF THE INVENTION

1. Field of the Invention

The present invention relates to an insulation-displacement terminal fitting.

2. Description of the Related Art

British Patent No. 1 451 357 discloses an insulation-displacement terminal fitting for use with a wire that has a core and a resin coating around the core. The insulation-displacement terminal fitting has first and second opposed side walls and a wire-receiving space therebetween. First and second insulation-displacement portions are formed by bending portions of respective first and second side walls to define a V-shape that projects into the wire-receiving space. The wire may be pushed transversely into the wire-receiving space so that the resin coating is cut open by projecting ends of the insulation-displacement portions. Further pushing brings the core of the wire into contact with the projecting ends of the insulation-displacement portions.

A large angle at the projecting end of the V-shaped insulation-displacement portion widens the contact area between the projecting end and the core, and hence improves contact reliability. On the other hand, a pulling force may act on the wire in its longitudinal direction. Cut-open surfaces of the resin coating are more likely to be caught and to resist the pulling forces, as the angle of the projecting ends of the V-shaped insulation-displacement portions is made smaller, i.e. as angles of the plates that form the V-shaped insulation-displacement portions approximate a right angle. Thus, smaller angles of the plates of the insulation-displacement portion restrict loose movement of the wire more effectively.

As described above, the conventional insulation-displacement terminal fittings provide either good contact reliability with the core or restriction of loose movement of the wire. However, one of these competing objectives typically is prioritized at the cost of the other by setting the angle of the V-shaped insulation-displacement portions.

The present invention was developed in view of the above situation, and an object thereof is to improve both contact reliability of a core and a function of restricting a loose movement of a wire.

### SUMMARY OF THE INVENTION

The invention is directed to an insulation-displacement terminal fitting that has a base wall with opposed first and second side edges. First and second opposed side walls extend from the respective first and second side edges of the base wall, such that a wire-receiving space is defined between the side walls. Each side wall is formed with at least V-shaped insulation-displacement portion that projects into the wire-receiving space.

The insulation-displacement terminal fitting is used with a wire that has a conductive core and a resin coating around the core. The wire may be inserted transversely into the wire-receiving space. As a result, projecting ends of the insulation-displacement portions cut into the resin coating. Further pushing brings the core of the wire into contact with the projecting ends of the insulation-displacement portions.

The side walls and/or the base wall are formed with at least one lock that projects into the wire-receiving space in a position spaced from the insulation-displacement portions along the longitudinal direction of the wire. The lock is configured to bite into the resin coating. As a result, the lock securely restricts longitudinal forces that could otherwise loosen the wire.

The lock may be formed by cutting and bending a portion of the bottom wall and/or a portion of the side wall. The cutting and bending enables the lock to be processed easily.

In one embodiment, the lock projects substantially at right angles to the side wall and/or the base wall. As a result, the lock and the cut-open surface of the resin coating are locked into each other by surfaces that are normal to the longitudinal axis of the wire to restrict loose movement of the wire.

In another embodiment, the lock is inclined obliquely so that the projecting end of the lock is more forward than the base end of the lock with respect to a direction opposite from an acting direction of an external force along the longitudinal direction of the wire. Consequently, the lock wedges into the resin coating if an external force acts on the wire in its longitudinal direction. Thus, a loose movement of the wire can be restricted securely.

The lock may project a sufficient distance into the wire receiving space to contact the core. Contact reliability with the core can be improved because both the insulation-displacement portions and the lock are brought into contact with the core of the wire. The lock may project substantially the same distance into the wire-receiving space as the insulation-displacement portions.

Preferably, the lock has a substantially single-plate configuration.

The insulation-displacement portions each may be formed by a pair of substantially planar portions that extend from the respective side wall at an angle different from 0° or 180°. The leading ends of the planar portions meet unitarily in the wire receiving space.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a plan view of a first embodiment,

FIG. 2 is an enlarged partial plan view of a second embodiment, and

FIG. 3 is an enlarged partial plan view of a third embodiment.

### DETAILED DESCRIPTION OF THE PREFERRED EMBODIMENTS

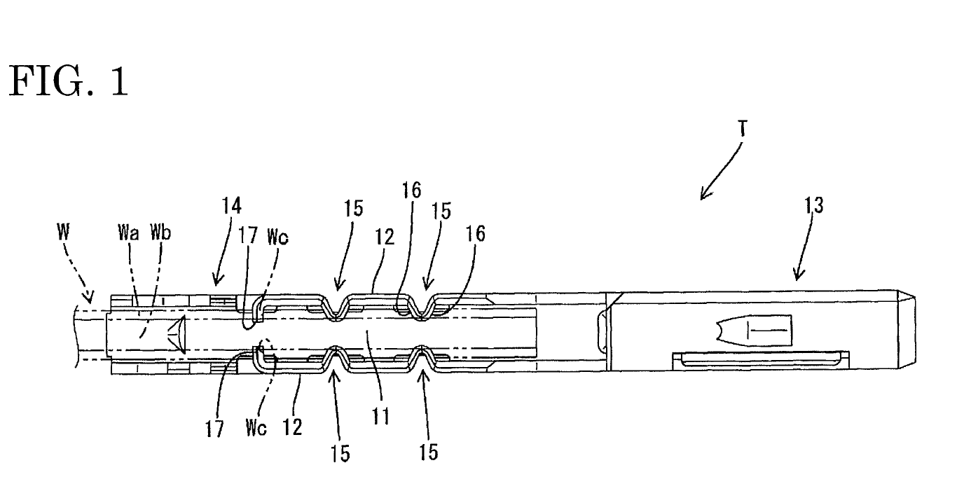

An insulation-displacement terminal fitting in accordance with the invention is identified by the letter T in FIG. 1, and is formed by bending a conductive metallic plate material that has been stamped or cut out into a specified shape. The insulation-displacement terminal fitting T includes opposite front and rear ends and an elongate base wall 11 with opposite first and second side edges. First and second opposed side walls 12 project substantially perpendicularly from the respective first and second side edges of the base wall 11 substantially over the entire length of the base wall 11.

A rectangular tubular engagement portion 13 is defined adjacent the front of the insulation-displacement terminal fitting T, and is configured for connection with a mating male terminal fitting (not shown). A crimping portion 14 is formed at the rear end of the insulation-displacement terminal fitting T and is configured for crimped or folded connection with a wire W.

Insulation-displacement portions 15 are formed between the engagement portion 13 and the crimping portion 14, and are configured for connection with the wire W by insulation displacement. More particularly, two longitudinally spaced insulation-displacement portions 15 project from each of the first and second side walls 12 into the wire-receiving space, and are aligned substantially normally to the base wall 11. Thus, a total of four insulation-displacement portions 15 are provided. The four insulation-displacement portions 15 are arranged to define front and rear transverse pairs, and the insulation-displacement portions 15 in each pair are spaced apart sufficiently to hold and/or connect the wire W therebetween.

Each insulation-displacement portion 15 is formed by bending a section of the side wall 12 into a substantially V-shape defined by front and rear planar plates 16. The plates 16 extend at substantially equal angles from the respective side wall 12 and meet at a projecting end of the insulation-displacement terminal fitting 15. Thus, each insulation-displacement portion 15 is substantially in the form of an isosceles triangle. An angle formed between the projecting ends of the plate portions 16 is about 60°.

The side walls 12 are formed with a pair of transversely arranged locks 17 that project into the wire-receiving space at positions between the insulation-displacement portions 15 and the crimping portions 14. The locks 17 are formed by making cuts in the side walls 12 and bending each cut portion to extend at substantially a right angle from the respective side wall 12. Each lock 17 is substantially I-shaped when viewed in a wire pushing direction with respect to the insulation-displacement terminal fitting T. The positions of both locks 17 in forward and backward directions, the projecting distances of the locks 17 from the side walls 12 and the bent direction of the locks 17 with respect to the side walls 12 have a mutually symmetrical relationship. Further, the projecting distances of the locks 17 from the side walls 12 are substantially equal to the projecting distances of the insulation-displacement portions 15 from the side walls 12. The projecting distances of the locks 17 and the insulation-displacement portions 15 from the side walls 12 are set so that the locks 17 and the insulation-displacement portions 15 can be held in contact with a core Wb of the wire W when the wire W is connected by insulation displacement. Accordingly, both the insulation-displacement portions 15 and the locks 17 penetrate into an insulation or resin coating Wa from its outer circumference to its inner circumference.

The wire W can be aligned parallel to the longitudinal direction of the terminal fitting T and pushed at least partly between the side walls 12 of the insulation-displacement terminal fitting T in a direction substantially normal to the longitudinal axis of the wire W. Pushing forces on the wire W cause the substantially V-shaped projecting ends to cut open the resin coating Wa of the wire W between the transversely paired insulation-displacement portions 15. The projecting ends of the insulation-displacement portions 15 then bite in the cut-open sections and are brought into contact with the core Wb. Thus, the wire W is connected with the insulation-displacement portions 15 by insulation displacement.

Simultaneously with the connection by insulation displacement, the wire W is pushed in between the pair of locks 17, and the I-shaped locks 17 bite into the resin coating Wa to cut it open. As a result the projecting ends of the locks 17 are brought into contact with the core Wb.

The plates 16 of each insulation-displacement portion 15 are aligned to define a relatively large angle of about 60° at the projecting end of each respective insulation-displacement portion 15. Therefore, large contact areas are ensured between the insulation-displacement portions 15 and the core Wa, and a sufficient contact reliability is achieved.

The locks 17 project at substantially right angles from the side walls 12. Thus, the surfaces of the locks 17 are substantially normal to the longitudinal axis of the wire W, and are held in contact with cut-open surfaces Wc of the resin coating Wa of the wire W. Accordingly, a force to pull the wire W backward along its longitudinal direction is resisted, and a loose backward movement of the wire W can be prevented by the engagement of the locks 17 with the cut-open surfaces Wc.

As described above, the substantially I-shaped, single-plate locks 17 restrict a loose longitudinal movement of the wire W. Additionally, the substantially V-shaped insulation-displacement portions 15 ensure a large contact area with the core Wb. Thus, the resin coating Wa is caught firmly to prevent loose longitudinal movement of the wire W, while contact reliability with the core Wb is improved. Accordingly, the locks 17 act as loose movement preventing means of the wire W for preventing a pulling of the wire W in the longitudinal direction and out of the insulation-displacement terminal fitting T.

The projecting ends of the locks 17 contact the core Wb in this embodiment. Therefore, a larger contact area and more positions of contact with the core Wb are ensured as compared with a case where only the insulation-displacement portions 15 contact the core Wb. Accordingly, contact reliability is enhanced.

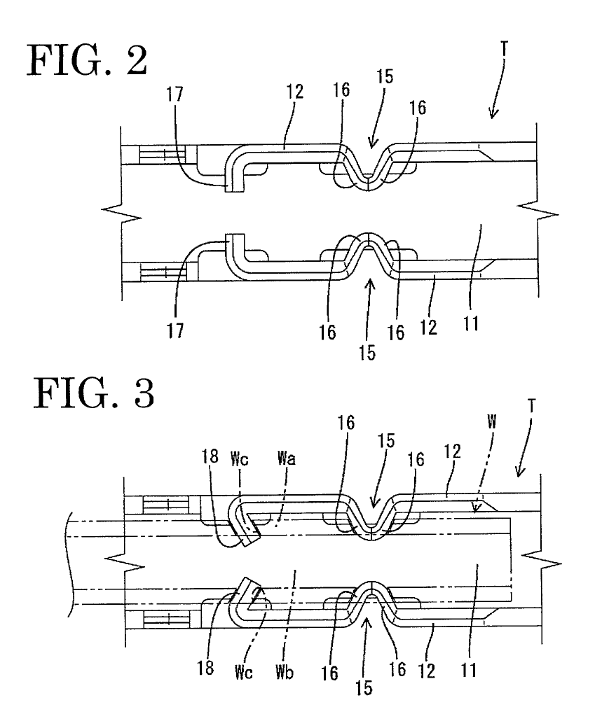

A second embodiment of the invention is described with reference to FIG. 2. The second embodiment has only one pair of insulation-displacement portions 15. The locks 17 are arranged behind the insulation-displacement portions 15 or on the side of the insulation-displacement portions 15 opposite to the engaging portion 13. The other construction is similar to or the same as in the first embodiment. Therefore, no description is given on its structure, function and effect, and the corresponding elements of the second embodiment merely are identified by the same reference numerals as the first embodiment.

A third embodiment of the present invention is described with reference to FIG. 3. The locks 18 of the third embodiment project obliquely forward from the side walls 12, and hence in a direction opposite from a backward pulling force on the wire W. Thus the locks 18 project toward the insulation-displacement portions 15 and the engaging portion 13. As a result, projecting ends of the locks 18 can contact the outer surface of the core Wb while slightly biting into the core Wb.

The locks 18 wedge in the resin coating Wa along the cut-open surfaces Wc in response to a backward longitudinal pulling force on the wire W. Thus, a loose backward movement of the wire W along its longitudinal direction can be restricted securely. Further, any backward displacement of the locks 18 that might occur will bring the locks 18 almost normal to the longitudinal direction of the wire W. As a result, the projecting ends of the locks 18 bite further into the core Wb to restrict backward displacements of the locks 18. Therefore, an excellent restriction of loose movement of the wire W can be realized.

The present invention is not limited to the above described and illustrated embodiments. For example, following embodiments are also embraced by the technical scope of the present invention as defined in the claims. Beside the following embodiments, various changes can be made without departing from the scope and spirit of the present invention as defined in the claims.

The locks are formed only at the side walls in the foregoing embodiments. However, the locks may be formed only at the bottom wall or both at the side walls and at the bottom wall according to the present invention.

The projecting ends of the locks are in contact with the core of the wire connected by insulation displacement in the foregoing embodiments. However, the locks may not contact the core in such a connected state of the wire according to the present invention. Accordingly, the projecting distance of the locks 17, 18 may be less than the projecting distance of the insulation-displacement portions 15.

The locks are arranged behind the insulation-displacement portions in the foregoing embodiments. However, the locks may be arranged before the insulation-displacement portions according to the present invention.

In the first embodiment two pairs of insulation-displacement portions are provided one after another. However, the locks may be arranged between the front pair of insulation-displacement portions and the rear pair of insulation-displacement portions.

Although the locking portions are bent forward in the foregoing embodiments, they may be bent backward according to the present invention.

One insulation-displacement terminal fitting T may be provided with different types of locking portions 17, 18.

What is claimed is:

1. An insulation-displacement terminal fitting (T), comprising: a base wall (11), first and second opposed side walls (12) projecting from opposite sides of the base wall (11) and defining a wire-receiving space between the side walls (12), each said side wall 12 being provided with at least one V-shaped insulation-displacement portion (15) projecting into the wire-receiving space, at least one lock (17; 18) projecting into the wire-receiving space in a position spaced from the insulation-displacement portions (15), whereby a wire (W) can be inserted into the wire-receiving space sufficiently for cutting a resin coating (Wa) of the wire (W) by projecting ends of the insulation-displacement portions (15) and bringing a core (Wb) of the wire (W) into contact with the projecting ends of the insulation-displacement portions (15), and wherein the lock (17; 18) bites into at least the resin coating (Wa).

2. An insulation-displacement terminal fitting according to claim 1, wherein the lock (17; 18) is formed by cutting and bending a portion of a selected one of the base wall (11) and the side wall (12).

3. An insulation-displacement terminal fitting according to a claim 1, wherein the lock (17) projects substantially at right angles to at least one of the side wall (12) and the bottom wall (11).

4. An insulation-displacement terminal fitting according to claim 1, wherein the lock (18) is inclined obliquely to project in a direction opposite from an acting direction of an external force along the longitudinal direction of the wire (W).

5. An insulation-displacement terminal fitting according to claim 1, wherein the lock (17; 18) projects by a sufficient distance for contacting the core (Wb).

6. An insulation-displacement terminal fitting according to claim 5, wherein the lock (17; 18) and the insulation-displacement portions (15) project substantially equal distances from the respective side walls.

7. An insulation displacement portion according claim 1, wherein the lock (17; 18) is of a single-plate configuration.

8. An insulation displacement portion according to claim 1, wherein the insulation-displacement portions (15) each are formed by two substantially planar portions (16) that extend at an angle from the respective side wall (12).

9. An insulation-displacement terminal fitting (T), comprising: a base wall (11), first and second opposed side walls (12) projecting from opposite sides of the base wall (11) and defining a wire-receiving space between the side walls (12), each said side wall 12 being provided with at least one V-shaped insulation-displacement portion (15) projecting into the wire-receiving space, each said side wall further having at least one substantially planar lock (17; 18) projecting into the wire-receiving space in a position spaced from the insulation-displacement portions (15), whereby a wire (W) can be inserted into the wirere-ceiving space sufficiently for cutting a resin coating (Wa) of the wire (W) by projecting ends of the insulation-displacement portions (15) and bringing a core (Wb) of the wire (W) into contact with the projecting ends of the insulation-displacement portions (15), and wherein the locks (17; 18) bite into at least the resin coating (Wa).

10. An insulation-displacement terminal fitting according to claim 9, wherein the locks (18) are aligned substantially normal to the respective side wall (12).

11. An insulation-displacement terminal fitting according to claim 9, wherein the locks (18) are inclined obliquely to project in a direction opposite from an acting direction of an external force along the longitudinal direction of the wire (W).

12. An insulation-displacement terminal fitting according to claim 9, wherein the locks (17; 18) project by a sufficient distance for contacting the core (Wb).

13. An insulation-displacement terminal fitting according to claim 12, wherein the locks (17; 18) and the insulation-displacement portions (15) project substantially equal distances from the respective side walls (12).

14. An insulation-displacement terminal fitting according to claim 9, comprising a front end defining an engaging portion (13) for engaging a mating terminal, the insulation displacement-terminal portions (15) being rearward of the engaging portion (13), the locks (17; 18) being rearward of the insulation-displacement portions (15).
